(19) United States
(12) Patent Application Publication
(10) Pub. No.: US 2020/0216744 A1
(43) Pub. Date: Jul. 9, 2020

(54) Method for Sealing Fractured Wells

(71) Applicant: University of Louisiana at Lafayette, Lafayette, LA (US)

(72) Inventor: Ning Liu, Lafayette, LA (US)

(21) Appl. No.: 16/717,078

(22) Filed: Dec. 17, 2019

Related U.S. Application Data
(60) Provisional application No. 62/789,197, filed on Jan. 7, 2019.

(51) Int. Cl. C09K 8/504

(52) U.S. Cl. CPC C09K 8/5045; C09K 2208/10

(57) ABSTRACT

The purpose for the invention is to develop a low-viscosity sealant that can be placed into the well fractures easily while providing long-term robust wellbore sealing. Nanoparticles like nanosilica particles are proposed and used to seal the fractures and keep the wellbore integrity. Application of nanosilica particles is beneficial as it has a low viscosity and requires low pressure to inject into fractures.

### CROSS REFERENCE TO A RELATED APPLICATION

This application claims priority to U.S. Provisional Application No. 62/789,197 titled “NANOPARTICAL SEALANT FOR FRACTURED WELLS”, filed on Jan. 7, 2019.

### STATEMENT REGARDING FEDERALLY SPONSORED RESEARCH OR DEVELOPMENT

Not applicable.

### REFERENCE TO A “SEQUENCE LISTING”, A TABLE OR A COMPUTER PROGRAM

Not applicable.

### DESCRIPTION OF THE DRAWINGS

The drawings constitute a part of this specification and include exemplary depictions of the METHOD FOR SEALING FRACTURED WELLS, which may take the form of multiple embodiments. It is to be understood that, in some instances, various aspects of the invention may be shown exaggerated or enlarged to facilitate an understanding of the invention. Therefore, drawings may not be to scale.

FIG. 1 provides the schematics of the nanosilica particles gelation process.

FIG. 2(A) provides an image of the nanosilica particles generated by a transmission electron microscopy.

FIG. 2(B) provides a line graph of the nanosilica size distribution, which measures the particle size in nanometers as a function of the channel percentage.

FIG. 3(A) provides a line graph of the effluence concentration and pressure drop change with nanosilica dispersion injected volume in limestone.

FIG. 3(B) provides a line graph of the effluent concentration and pressure drop change with nanosilica dispersion injected volume in sandstone.

FIG. 4(A) shows a picture of the nanosilica gelation process at the outset when a high concentration of calcium ion (Ca²⁺) is added to the nanosilica dispersion.

FIG. 4(B) shows a picture of the nanosilica gelation process two hours after the Ca²⁺ was added as shown in FIG. 4(A).

### FIELD OF THE INVENTION

This invention generally relates to the field of oil and gas wellbore integrity repairs. More specifically, this invention relates to the use of low-viscosity, nanoparticle sealants in the oil and gas industry to provide long-term robust wellbore sealing.

### BACKGROUND OF THE INVENTION

One of the most serious changes encountered in oil and gas wells is failure of the cement sheaths and its debonding from casing or formation rock, resulting in annular gaps and/or fractures in the cement. Leakage of gases and hydrocarbon fluids through the annular gap/fracture can occur during drilling, hydraulic fracturing, and production, or after abandonment, and may endanger the health and safety of field workers and the environment. For example, the BP Deepwater Horizon oil spill occurred in the U.S. Gulf of Mexico with devastating effects on the local environment and on public perception of offshore oil and gas drilling. The incident sent toxic fluids and gas shooting up the well, leading to an explosion on board that killed several people and injured many others.

Wellbore cement cracks can be generated either by chemical attack from formation fluids or by mechanical stressing caused by pressure or thermal cycling resulting from the production of hot reservoir fluids or injection of relatively cold surface fluids. Particularly, with the emergence of unconventional oil and gas wells in North America shale plays, the introduction of multi-stage fracturing completion techniques in the United States unconventional shale plays include more extreme temperature and pressure cycles to the wellbore environment. Each temperature cycle reduces the temperature inside the casing by as much as 200 degrees Fahrenheit, as cold fracturing fluid is pumped from the surface and each pressure cycle increases the pressure inside the casing by as much as a 10,000 psi as each fracturing stage must exceed the pressure required to open and sustain a fracture in the reservoir rock. The larger and more repetitive stresses associated with multistage hydraulic fracturing can lead to cement sheath integrity failure and result in potential well leaking risk during production.

Typically, wells with poor cementing or suspected leaks are repaired with a cement squeeze, in which new cement is injected through perforations created in the casing near the suspected source or leakage pathway to fill the pathway. However, fractures or leakage pathways with small apertures are often difficult for oilfield cement to repair, because the cement slurry is potentially screened out from dispersing fluid and cannot enter the fracture as described. In addition, cement slurry typically has a high viscosity and requires higher injected pressure to squeeze the cement into the leakage pathway.

### SUMMARY OF THE INVENTION

The purpose for the invention is to develop a low-viscosity sealant that can be placed into the well fractures easily while providing long-term robust wellbore sealing. Nanoparticles like nanosilica particles are used to seal the fractures and keep the wellbore integrity.

### DESCRIPTION OF THE INVENTION

Colloidal silica, a stable aqueous dispersion of discrete nanosize of amorpohous silicon dioxide, can form long-chain networks gel by particle collision, bonding, and aggregation. Particle bonding probably results from formation of siloxane (Si—O—Si) bonds at points of interparticle contact. Bonding is promoted by reducing the pH of the solution, by adding cations to the solution, by increasing particle concentration, or by increasing temperature. Gelation occurs when particle aggregation ultimately forms a uniform 3D network.

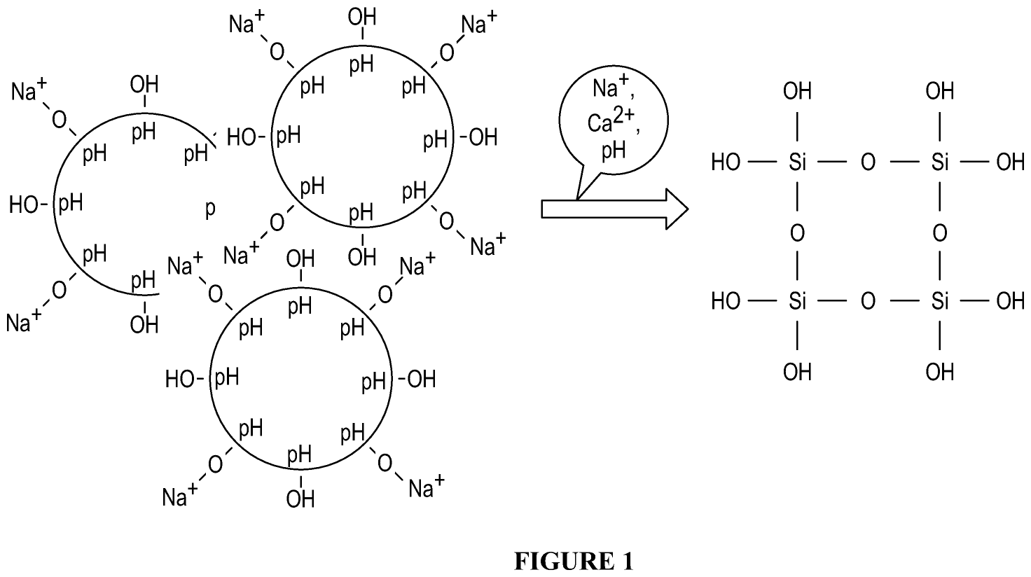

FIG. 1 displays the nanosilica particles gelation process. In wellbore cement fractures treatment, nanosilica partilicles are co-injected into fractures with a particle gelation trigger such as sodium ion (Na⁺), calcium ion (Ca²⁺), or acid. Depending on the silica nanoparticle and particle gelation trigger combinations, gelation time and gel strength can be controlled at an appropriate strength. Wellbore cement fractures can be sealed as the silica gel forms in the fractures.

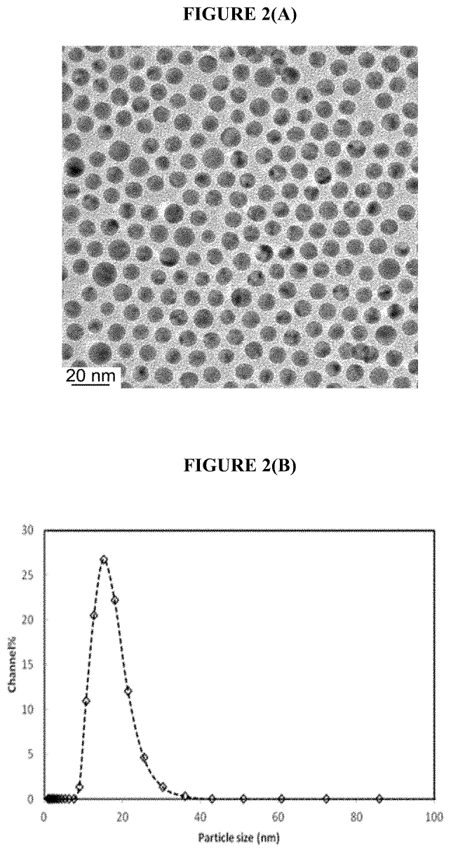

FIGS. 2(A) and 2(B) show a kind of surface modified nanosilica particles. The nanosilica particles can resist harsh reservoir conditions and easily transport in porous materials without plugging.

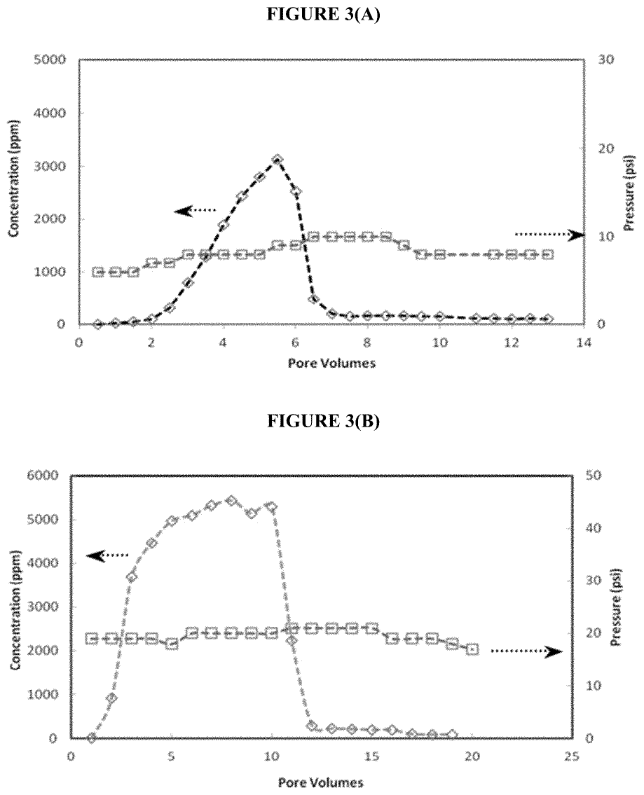

FIG. 3 shows the results of the surface modified nanosilica particle transport in two different reservoirs: limestone (FIG. 3(A)) and sandstone (FIG. 3(B)). The pressure drop along the core samples and high nanosilica recovery indicate that the silica nanoparticles easily transport in the reservoir without the formation damage.

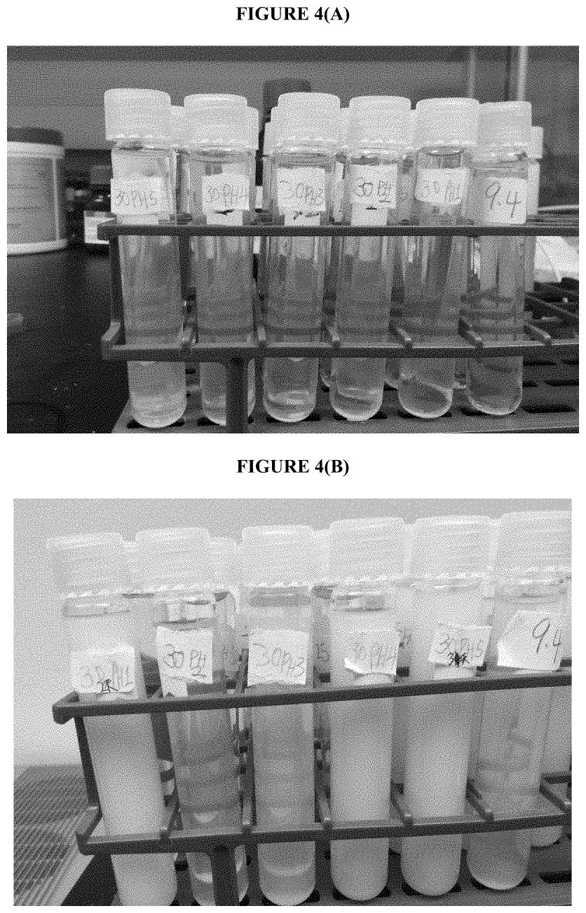

FIGS. 4(A) and 4(B) show the nanosilica gelation process when high concentrations of Ca²⁺ are added in the nanosilica dispersion. Nanosilica gelation was initiated by this edition and the silica gel is formed. Particles gelation in the fracture can be promoted by either leached Ca²⁺ from the fracture or the gel trigger co-injected with the particles. An in-situ gelation process can be initiated and, in the same time, the fractures of the wellbore are sealed.

Fractures with small apertures are often difficult for oilfield cement to repair because the cement slurry can be screened out from dispersing fluid and cannot enter the fracture. Nanosilica particles (as seen in FIG. 2(A)) have a particle size in the range of several to tens of a nanometer. They can easily transport the porous media of wellbore cement and reach all of the small apertures.

Nanosilica as wellbore cement fracture sealant provides new wellbore integrity treatment for cement fractures from well drilling and completion, and for small size cement annular caps or fractures during well production. The small particle size and low viscosity allows for the nanosilica dispersion to be easily injected into the cement fractures with low injection pressure.

Use of nanosilica as a wellborne fractures sealant has several advantages. First, the sealant can be easily pumped into the fracture due to the low viscosity. Typically, wells with poor cementing or suspect leaks are repaired with a cement squeeze. But cement slurry has high viscosity, needs high pressure to be pumped into the fracture, and in some cases is too thick to be injected into the fracture because of the fracture's size. Nanosilica dispersion has a low viscosity and can easily be injected into the fracture with low injection pressure. Second, nanosilica is inorganic and environmentally friendly as compared to the organic gels currently known in the art. Nanosilica gelation can be triggered externally (e.g., by mixing with salt solutions or changing the pH), so there should also be fewer environmental restrictions and permitting requirements for its use given that the material originates in the same place it is to be injected. Third, nanosilica can be inexpensively produced on a large commercial scale.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment. Moreover, the terms “substantially” or “approximately” as used herein may be applied to modify any quantitative representation that could permissibly vary without resulting in a change to the basic function to which it is related.

I claim:

1. A method for repairing fractures in a wellbore comprising:
identifying one or more fractures in a wellbore;
preparing a solution, wherein said solution comprises nanoparticles and a particle gelation trigger;
injecting said solution into said one or more fractures; and
allowing said solution to set;
wherein a gelation process occurs and thereafter seals said one or more fractures.

2. The method of claim 1, wherein said nanoparticles comprise nanosilica particles.

3. The method of claim 2, wherein said nanosilica particles comprise colloidal silica.

4. The method of claim 1, wherein the solution further comprises cations.

5. The method of claim 1, wherein the solution is heated.

6. The method of claim 1, wherein the particle gelation trigger comprises one or more of the following: sodium ions, calcium ions, and acid.
